(19) United States
(12) Patent Application Publication
(10) Pub. No.: US 2013/0036701 A1
(43) Pub. Date: Feb. 14, 2013

(54) Wood Flooring System

(71) Applicant: Michael YU, Irwindale, CA (US)

(72) Inventor: Michael YU, Irwindale, CA (US)

(21) Appl. No.: 13/207,420

(22) Filed: Aug. 11, 2011

(51) Int. Cl. E04B 5/00; B32B 37/14; B32B 38/04; B32B 37/02

(52) U.S. Cl. 52/588.1; 52/578; 156/60; 156/278

(57) ABSTRACT

A wood flooring system includes a plurality of flooring panels being connected edge to edge, wherein each of the flooring panels comprises a top refinishable element and a bottom substrate bonded underneath the top refinishable element. The top refinishable element is made of natural material adapted to be refinished due to surface damage. The bottom substrate is made of heat and moisture barrier material to minimize the top refinishable element being reacted to changes in humidity with minimum expansion of the top refinishable element.

### BACKGROUND

1. Field of the Invention

The present invention relates to flooring systems. More particularly, the present invention relates to a wood flooring system which provides a high quality natural hardwood top layer to enhance the aesthetic appeal and low cost substrate layer for moist and heat resistance.

2. Discussion of the Related Art

Most people recognize quality with solid hardwood floors since the richness of hardwood flooring can add remarkable charm to any room. A high quality hardwood flooring system can add real value to a home. Therefore, such solid hardwood floors are commonly found in quality houses. However, the hardwood flooring system is relatively expensive and is hard to take care. Especially, the solid wood floors will react to changes in humidity and will need proper expansion allowances due to the change of ambient temperature. It is not environmental friendly because the solid wood floors are made of solid wood cut from the trees. And, the scratch resistance and impact resistance of the solid wood floor are relatively low.

An alternative flooring system is laminate flooring in which it can solve all the common problems of the solid wood floors. Laminate floors are extremely impart, scratch, sunlight fade and stain resistant. Laminate floors are relatively easy to take care that they do not need a wax or polish. Therefore, laminate floors have a realistic impression of solid wood floors and have become one of popular alternative to solid wood floors. However, unlike the solid wood floors, laminate floors cannot be repair in which the entire laminate floor strip must be replaced. Generally, the laminate floor strips are joined with tongue and groove joinery so that the installation of the laminate floor strips is relatively easier. However, the replacement of the laminate floor strip will be extremely complicated and costly. Laminate floors are noisy when walked on. Most importantly, the life span of solid wood floors can be more than 30 years that high quality solid wood floors can last for a lifetime with proper care and refinishing. However, the life span of laminate floors can be 5 to 10 years.

### BRIEF SUMMARY OF THE INVENTION

The present invention overcomes the above mentioned drawbacks and limitation by configuring the wood flooring system.

The primary objective of the present invention is that the wood flooring system can achieve the advantages of hardwood floor and laminate floor and solve the problems of hardwood floor and laminate floor.

The wood flooring system comprises a plurality of flooring panels being connected edge to edge, wherein each of the flooring panels comprises a top refinishable element and a bottom substrate bonded underneath the top refinishable element.

Another objective of the present invention is that the top refinishable element is made of natural material adapted to be refinished due to surface damage. The top refinishable element can be refinished or repaired to extend the life span of the flooring panel. The top refinishable element can be sanded and buffered, while sealer layer can be re-applied on the top refinishable element to restore the original beauty thereof.

Another objective of the present invention is that the top refinishable element commands higher values than laminate flooring. The top refinishable element is natural, non-allergenic product that can add real value to a home.

Another objective of the present invention is that only the top refinishable element is made of nature material such as solid wood or bamboo strip so that the flooring panel is an environmental friendly product to minimize the use of natural material.

Another objective of the present invention is that the bottom substrate is made of heat and moisture barrier material to minimize the top refinishable element being reacted to changes in humidity with minimum expansion of the top refinishable element.

Another objective of the present invention is that the bottom substrate, such as particleboard or bamboo fiber, can be manufactured in low cost to reduce the overall cost of the flooring panel. The cost of flooring panel with the top refinishable element of the present invention can be as low as the laminate flooring and is relatively lower than the hardwood flooring.

Another objective of the present invention is that the manufacturing method of the flooring panel is simply adhering the top refinishable element on the bottom substrate.

Another objective of the present invention is that the installation of the flooring panel of the present invention is simple and easy that can be completed by one person (DIY). Preferably, the flooring panels are joined with tongue and groove joinery. Alternative installation methods, such as glue, staple, float, or any other conventional methods can also be used for installing the flooring panels of the present invention.

For a more complete understanding of the present invention with its objectives and distinctive features and advantages, reference is now made to the following specification and to the accompanying drawings.

### BRIEF DESCRIPTION OF THE DRAWING(S)

FIG. 1 is a schematic view of the wood flooring system in accordance with the present invention.

FIG. 2 is a sectional view of the flooring panel of the wood flooring system in accordance with the present invention.

FIG. 3 is a flow diagram of the manufacturing method of the flooring panel in accordance with the present invention.

FIG. 4 is a table showing the comparison among the present invention, the conventional hardwood floor, and conventional laminate floor.

### DETAILED DESCRIPTION OF THE INVENTION

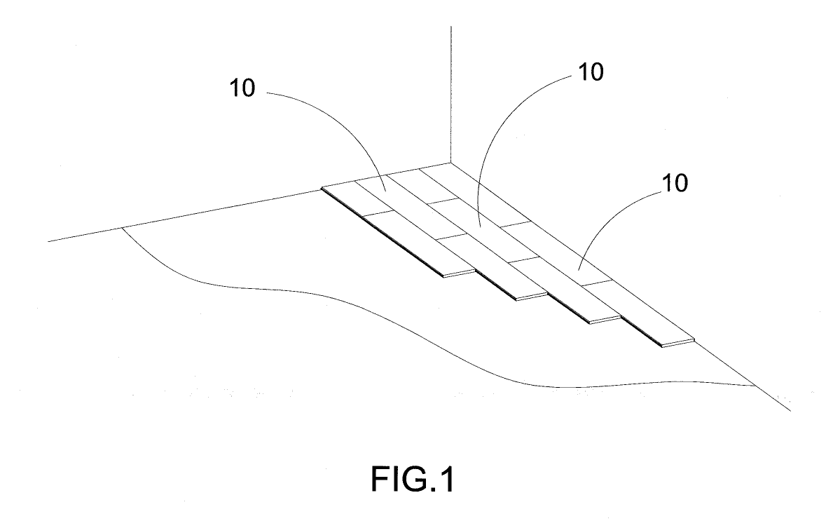

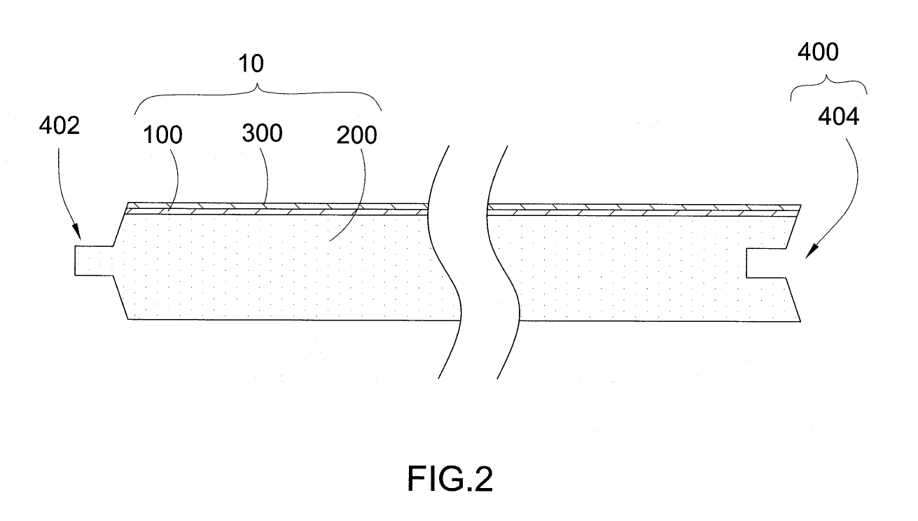

Referring to FIGS. 1 and 2, a wood flooring system in accordance with the present invention is disclosed. The wood flooring system comprises a plurality of flooring panels 10 being connected edge to edge.

In accordance with a preferred embodiment of the present invention, each of the flooring panels 10 comprises a top refinishable element 100, a bottom substrate 200 bonded underneath the top refinishable element 100, and a sealer layer 300 coated on the top refinishable element 100.

With regard to the top refinishable element 100, it is made of natural material, such as solid wood or bamboo strip. The top refinishable element 100 can be refinished due to surface damage. For example, the top refinishable element 100 can be sanded and buffered to repair the scratch on the surface of the top refinishable element 100 as the conventional hardwood flooring.

It is preferred that the top refinishable element 100 is adhered to the bottom substrate 200. The bottom substrate 200 is made of moisture barrier material to prevent moisture absorbed by the top refinishable element 100 from the bottom of the flooring panel 10. Also, the bottom substrate 200 is made of heat barrier material to prevent heat transmitting to the top refinishable element 100 from the bottom of the flooring panel 10. Therefore, the heat and moisture barrier is formed by the bottom substrate 220, the top refinishable element 100 to minimize the top refinishable element 100 being reacted to changes in humidity with minimum expansion of the top refinishable element 100.

More important, the bottom substrate 200 is made of low cost material and is easy to mass-manufacture. In accordance with the preferred embodiment of the present invention, the bottom substrate 200 can be particleboard or can be made of bamboo fiber.

With regard to the flooring panel 10, the thickness of the top refinishable element 100 is thinner than the thickness of the bottom substrate 200. Therefore, the overall material usage of the nature material to make the top refinishable element 100 will be minimized in comparison with the convention solid hardwood flooring panel. It is appreciated that the flooring panel 10 of the present invention is an environmental friendly product. It is worth note that the conventional hardwood flooring panel is made of solid wood so that the concern has been for the loss of so many trees. Accordingly, it takes approximately 100 years for the hardwood tree to mature in which the mature hardwood tree can be used for making hardwood flooring panels. By reducing the material usage of the hardwood tree to make the top refinishable element 100, the flooring panel 10 of the present invention can be considered as earth friendly alternative to the hardwood flooring panel.

By reducing the thickness of the top refinishable element 100 in comparison with the conventional hardwood flooring, the nature material of the top refinishable element 100 will have minimum expansion due to the changes in humidity. That is to say, the expansion of the top refinishable element 100 will be smaller than that of the conventional hardwood flooring so that the installation of the flooring panel 10 of the present invention is less complicated than the installation of the conventional hardwood flooring.

In accordance with the preferred embodiment of the present invention, the sealer layer 300 is coated on the refinishable element 100 as the refinish layer of the flooring panel 10. The sealer layer 300 can be polyurethane for the top refinishable layer 100. Like the conventional hardwood flooring, the flooring panel 10 of the present invention can be refinished by cleaning and sanding the surface of the top refinishable element 100 and by applying the sealer layer 300 on the top refinishable element 100 to restore the flooring panel 10 original beauty.

FIG. 2 shows the tongue and groove structure 400 of the flooring panel 10. Each of the flooring panels 10 has a tongue structure 402 at a portion of the peripheral edge and a groove structure 404 at a portion of the peripheral edge. Therefore, the flooring panels 10 are joined with tongue and groove joinery. It is preferred that the tongue and groove structure 400 is formed at the peripheral edge of the bottom substrate 200 of the flooring panel 10.

It is worth note that the flooring panels 10 are interlocked with each other. If one of the flooring panels 10 needs to be repaired, the damaged flooring panels 10 can be refinished without removing the entire flooring system. Unlike the conventional laminate flooring, if one of the laminate flooring panels is damaged, the damaged laminate flooring panel cannot be repaired and must be removed from the entire flooring system. It is appreciated that the flooring panels 10 of the present invention can be installed by other methods such as glue, staple, or float.

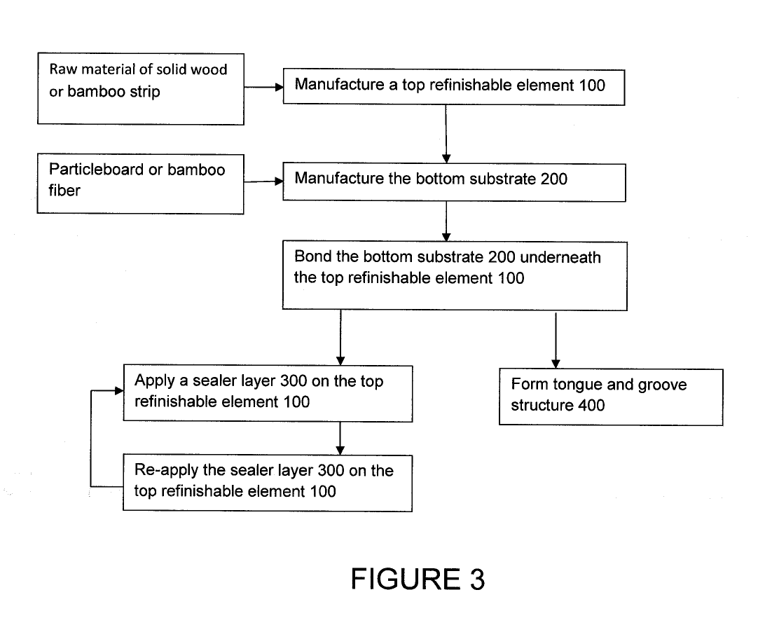

FIG. 3 shows the manufacturing method of the flooring panel 10. The method comprises the following steps.

(A) Manufacture the top refinishable element 100. The top refinishable element 100 can be made of solid wood cut from trees as the solid piece of wood or can be made of bamboo strip cut from bamboo tree.

(B) Manufacture the bottom substrate 200. The manufacturing process of the bottom substrate 200 is simple, easy, and is in low cost. Particleboard or bamboo fiber can be considered as best exemplar of the bottom substrate 200.

(C) Bond the bottom substrate 200 underneath the top refinishable element 100. Preferably the bottom substrate 200 is adhered to the top refinishable element 100.

The above method further comprises a step of applying the sealer layer 300 on the top refinishable element 100 and a step of forming tongue and groove structure 400 at the peripheral edge of the flooring panel 10.

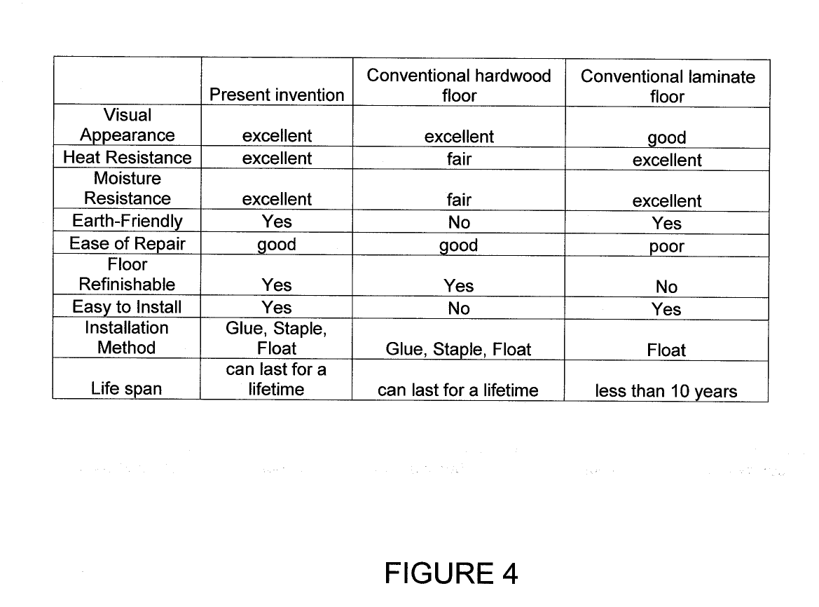

FIG. 4 shows the comparison among the present invention, the conventional hardwood floor, and conventional laminate floor.

The visual appearance of the present invention is as good as the visual appearance of the conventional hardwood floor because of the top refinishable element 100 which is made of natural material, such as solid wood or bamboo strip. The heat resistance and moisture resistance of the present invention is as good as the conventional laminate floor because of the bottom substrate 200.

Comparing the present invention with the conventional hardwood floor, the present invention is an earth-friendly product because it consumes minimum nature material. Because of the sealer layer 300, the present invention can be refinished as the conventional hardwood floor and the present invention is easy to repair. The installation of the present invention is as simple as the conventional laminate floor through the tongue and groove structure 400. The life span of the present invention can last for a lifetime as the conventional hardwood floor.

While the embodiments and alternatives of the present invention have been shown and described, it will be apparent to one skilled in the art that various other changes and modifications can be made without departing from the spirit and scope of the present invention.

What is claimed is:

1. A flooring system comprising a plurality of flooring panels being connected edge to edge, wherein each of said flooring panels comprises a top refinishable element and a bottom substrate bonded underneath said top refinishable element, wherein said top refinishable element is made of natural material adapted to be refinished due to surface damage, wherein said bottom substrate is made of heat and moisture barrier material to minimize said top refinishable element being reacted to changes in humidity with minimum expansion of said top refinishable element.

2. The flooring system of claim 1 further comprising a sealer layer coated on said top refinishable element, wherein said sealer layer is capable of being re-applied to said top refinishable element during refinishing said top refinishable element.

3. The flooring system of claim 1 wherein said top refinishable element is adhered to said bottom substrate.

4. The flooring system of claim 2 wherein said top refinishable element is adhered to said bottom substrate.

5. The flooring system of claim 1 wherein a thickness of said top refinishable element is thinner than a thickness of said bottom substrate.

6. The flooring system of claim 4 wherein a thickness of said top refinishable element is thinner than a thickness of said bottom substrate.

7. The flooring system of claim 1 wherein said top refinishable element is made of solid wood and said bottom substrate is particleboard.

8. The flooring system of claim 6 wherein said top refinishable element is made of solid wood and said bottom substrate is particleboard.

9. The flooring system of claim 1 wherein said top refinishable element is made of solid wood and said bottom substrate is bamboo fiber.

10. The flooring system of claim 6 wherein said top refinishable element is made of solid wood and said bottom substrate is bamboo fiber.

11. The flooring system of claim 1 wherein said top refinishable element is made of bamboo strip and said bottom substrate is particleboard.

12. The flooring system of claim 6 wherein said top refinishable element is made of bamboo strip and said bottom substrate is particleboard.

13. The flooring system of claim 8 wherein said flooring panels are joined with tongue and groove joinery.

14. The flooring system of claim 10 wherein said flooring panels are joined with tongue and groove joinery.

15. The flooring system of claim 12 wherein said flooring panels are joined with tongue and groove joinery.

16. Method of manufacturing a flooring panel, comprising the step of:
(a) manufacturing a top refinishable element, wherein said top refinishable element is made of natural material adapted to be refinished due to surface damage;
(b) manufacturing a bottom substrate, wherein said bottom substrate is made of heat and moisture barrier material, wherein a thickness of said top refinishable element is thinner than a thickness of said bottom substrate; and
(c) bonding said bottom substrate underneath said top refinishable element so that said top refinishable element is minimized being reacted to changes in humidity with minimum expansion of said top repairable element.

17. The method of claim 16 further comprising a step of applying a sealer layer on said top refinishable element, wherein said sealer layer is capable of being re-applied to said top refinishable element during refinishing said top refinishable element.

18. The method of claim 17 wherein said top refinishable element is adhered to said bottom substrate in said step (c).

19. The method of claim 18 wherein said top refinishable element is made of solid wood and said bottom substrate is particleboard.

20. The method of claim 18 wherein said top refinishable element is made of solid wood and said bottom substrate is bamboo fiber.

21. The method of claim 18 wherein said top refinishable element is made of bamboo strip and said bottom substrate is particleboard.

22. The method of claim 19 further comprising a step of forming tongue and groove structure at a peripheral edge of said flooring panel, wherein said flooring panels are joined with tongue and groove joinery.

23. The method of claim 20 further comprising a step of forming tongue and groove structure at a peripheral edge of said flooring panel, wherein said flooring panels are joined with tongue and groove joinery.

24. The method of claim 21 further comprising a step of forming tongue and groove structure at a peripheral edge of said flooring panel, wherein said flooring panels are joined with tongue and groove joinery.
